(19) United States
(12) Patent Application Publication
(10) Pub. No.: US 2003/0214137 A1
(43) Pub. Date: Nov. 20, 2003

(54) Vehicle latch assembly having modular components

(76) Inventors: Veronique Mejean, Saint Die (FR); Eric Colin, Netz (FR); Mathias Barth, Azerailles (FR)

Correspondence Address: CARLSON, GASKEY & OLDS, P.C., 400 WEST MAPLE ROAD, SUITE 350, BIRMINGHAM, MI, 48009, US

(21) Appl. No.: 10/405,967

(22) Filed: Apr. 2, 2003

(30) Foreign Application Priority Data
Apr. 2, 2002 (GB) 020752.7

(51) Int. Cl. E05C 1/02

(52) U.S. Cl. 292/177

(57) ABSTRACT

A latch assembly is constructed from a plurality of modular sub-assemblies, such as a retention module sub-assembly, a release module sub-assembly, and an actuator module sub-assembly. Each of the sub-assemblies may incorporate various functional characteristics, such as motorized operation. Combining sub-assemblies having different functions allows construction of different latch assemblies while taking advantage of common sub-assembly parts, eliminating the need to construct completely new latch assembly designs to accommodate different functions.

### REFERENCE TO RELATED APPLICATIONS

The present invention claims priority to United Kingdom (GB) patent application number 0207525.7, filed Apr. 2, 2002.

### TECHNICAL FIELD

The present invention relates to vehicle latch assemblies, and more particularly to a vehicle latch assembly having modular components that can be used in latches having different specifications and/or functions.

### BACKGROUND OF THE INVENTION

Vehicle latches are used to releasably secure vehicle doors in a closed position. They are mounted in the vehicle door and include a retention plate having a mouth that receives a striker, which is usually formed as a fixed structure in the vehicle. The retention plate includes an upstanding claw pivot pin and an upstanding pawl pivot pin, both of which are in a fixed position relative to the retention plate. Some known latches also include a pawl that is rotatably fixed relative to a pawl pivot pin. In this type of latch structure, the pawl pivot pin is rotatable relative to the retention plate.

The latch assembly also includes a rotatable claw pivotally mounted on the claw pivot pin. The rotatable claw has a claw mouth that can receive the striker. A pawl is pivotally mounted on the pawl pin and operably engages a first safety abutment or a closed abutment of the claw to retain the claw, and therefore the striker, in a first safety or fully closed position. The pawl can be rotated out of engagement with the claw, allowing the claw to rotate to its open position to release the striker and allow the door to open. The claw may be biased to its open position by a claw spring and the pawl may be biased to a claw engagement position by a pawl spring.

Modern cars are designed with a passenger safety cell to protect the occupants of the vehicle if a traffic accident occurs. The proper operation of the safety cell relies significantly on the doors remaining closed. Components in the latch assembly, particularly the retention plate, claw, claw pin, pawl and pawl pin, must have sufficient strength to resist the high impact loads occurring during a traffic accident and prevent the door from bursting open.

Latches on different vehicles and even different latches on one particular vehicle may have different security and operating modes. For example, a given latch may be openable by an inside door handle operation, openable by an outside door handle operation, lockable by an inside sill button operation, and lockable by an outside key barrel. Further, the operating modes of a given latch may include an unlocked mode, a locked mode (e.g., where operation of an outside door handle does not unlatch the latch but operation of an inside door handle does unlatch the latch), a superlocked mode (e.g., where any number of operations of an inside or an outside door handle, in any order, does not unlatch the latch), and a child safety mode (e.g., where operation of an inside door handle does not unlatch the latch, whereas operation of an outside door handle may or may not unlatch the latch depending upon whether the door is locked or unlocked).

Moreover, a certain sequence of events can be used to perform desired functions. For example, an override unlocking function may be included in the latch assembly to prevent vehicle keys from being locked in the vehicle. In the override unlocking function, operation of an inside door handle may unlock the latch and unlatch the latch at the same time. When the door is subsequently closed, the door is unlocked and can therefore be opened by operation of the outside door handle. The override unlocking function is also useful to open a locked door during a child safety mode by allowing operation of an inside door handle to unlock the latch without unlatching the latch, enabling a subsequent operation of an outside door handle to conduct the actual unlatching process.

The latch assembly may also be structured so that a sill button associated with certain types of latches, such as driver door latches, cannot be depressed when the door is open. This is also to prevent keys from being locked in the vehicle. In this type of structure, the only way to lock the latch from outside the vehicle is to close the door and insert a key into the key barrel of the latch assembly.

The latch assembly may also be designed to require an outside door handle to be lifted when the door is in the open position before allowing the sill button to be pushed down to lock the door when the door is subsequently closed. Thus, the driver has to perform a specific sequence of events (i.e., lift the outside door handle and then depress the sill button) to lock the door. This design is also aimed to prevent keys from being locked in the vehicle.

Thus, it can be seen that the mechanisms of the latch assembly itself, as opposed to devices remote from the latch assembly, can provide multiple lock operating modes and functions. Ultimately, whichever mechanism is used, the door will only open when the pawl is moved out of engagement from the claw. Thus, locking, superlocking, and child safety modes all relate to either providing a connection between the door handle and the pawl to move the pawl or breaking or blocking connection between the door handle and the pawl to prevent movement of the pawl.

Vehicle door latches are typically mounted at the rear of a vehicle car door, while the pivot point of the vehicle door is typically mounted at a front edge. Further, an inside door handle is mounted on the inside of the door toward the door's front edge. Therefore, a connection mechanism is needed to connect the inside door handle with the door latch. Depending on the location of the inside door handle and the desired function of the connection mechanism with respect to the latch, different latches require different types of connection structures and orientations to be able to actuate the door latch. For example, some latching assemblies use the connection mechanism to simply provide unlatching of the door, whereas in other cases the connection mechanism provides both unlocking and unlatching of the door.

To reduce costs, there is a desire to standardize latches fitted to the front and rear vehicle doors in a given vehicle and also standardize vehicle latches for different vehicle models. There is also a desire to standardize latch components for latches to be installed in different vehicle makes and models.

### SUMMARY OF THE INVENTION

The present invention is directed to a latch assembly having a retention module sub-assembly, a release module sub-assembly, and an actuator module sub-assembly. The retention module sub-assembly includes a retention plate having a mouth adapted to accept a striker, a claw that releasably retains a striker, and a pawl engageable with the claw to hold the claw so that it retains the striker. The release module sub-assembly includes a body, a pawl lifter that is rotatable to lift the pawl away from the claw so that the claw releases the striker. The actuator module sub-assembly includes a backplate and an inside release lever operable by an inside release handle to selectively move the pawl lifter.

By creating separate, modular sub-assemblies, the invention allows manufacturing of latches having different specifications by simply changing sub-assemblies. For example, if two different vehicle manufacturers require two different latch functions (e.g., with and without manual override unlocking), the latch assemblies for both manufacturers may still contain the same retention module sub-assembly while incorporating different release module sub-assemblies (i.e. a manual override unlocking release module subassembly for one manufacturer and a powered override unlocking release module subassembly for another manufacturer). The invention allows replacement of only the relevant sub-assembly rather than requiring two completely different latch assembly designs to accommodate the different latch functions.

Further, the release module sub-assembly can be produced according to different specifications (e.g., low line, medium line and high line), allowing for corresponding low line, medium line and high line latches to be manufactured by simply using different release module sub-assemblies rather than completely different latch assembly structures.

Thus, the modular sub-assembly structure of the inventive latch assembly allows different combinations of modular sub-assemblies to be used depending upon the particular installation requirement of the latch assembly. For example, different modular sub-assembly combinations can be used for the front and rear doors of the same vehicle. Also different actuator module sub-assemblies can be used for different vehicle ranges for a particular vehicle manufacturer and also for different vehicle manufacturers. The invention therefore allows construction of latch assemblies having many different specifications from a limited number of modular sub-assemblies.

### BRIEF DESCRIPTION OF THE DRAWINGS

The invention will now be described, by way of example only, with reference to the accompanying drawings in which:

FIG. 1 is an isometric view of an actuator module sub-assembly of an embodiment of the present invention;

FIG. 2 is an isometric view of a release module sub-assembly of an embodiment of the present invention;

FIG. 3 is an isometric view of a retention module sub-assembly of an embodiment of the present invention;

FIG. 4 is an isometric view of a latch assembly of an embodiment of the present invention;

FIGS. 5 to 9 illustrate a method of assembling a latch according to an embodiment of the invention;

FIGS. 10 to 15 illustrate specific components of latches according to embodiments of the present invention;

FIGS. 16 and 17 illustrate schematic representations of two Bowden cables, of differing length, for use with latches according to an embodiment of the present invention.

FIG. 18 is an isolated view of a lock link used in an embodiment of the invention.

### DETAILED DESCRIPTION OF THE EMBODIMENTS

In this specification, similar components shown in different embodiments and different figures are labelled with the same reference number.

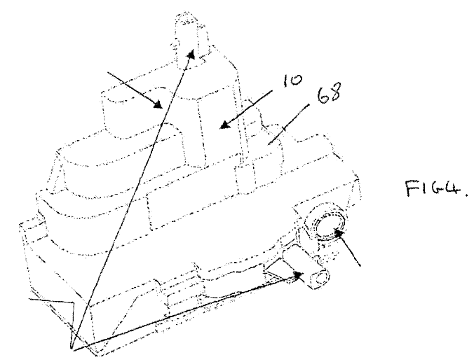

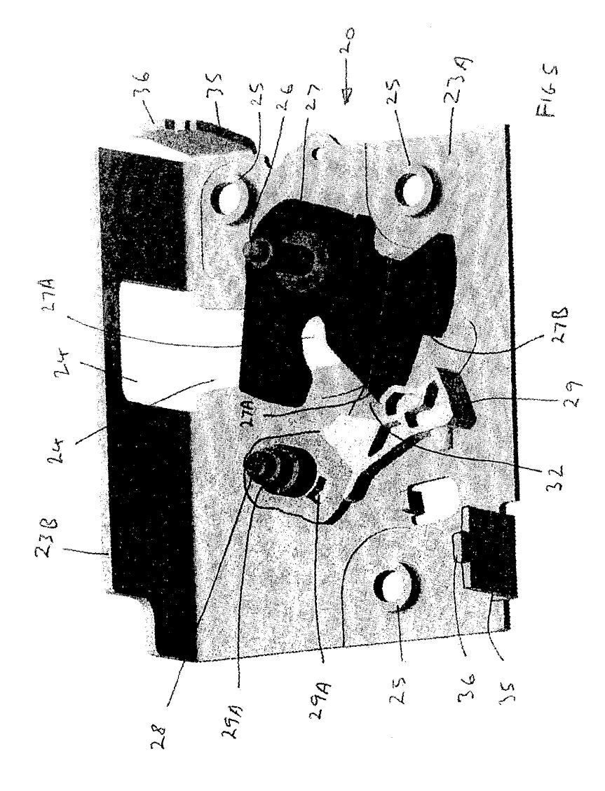

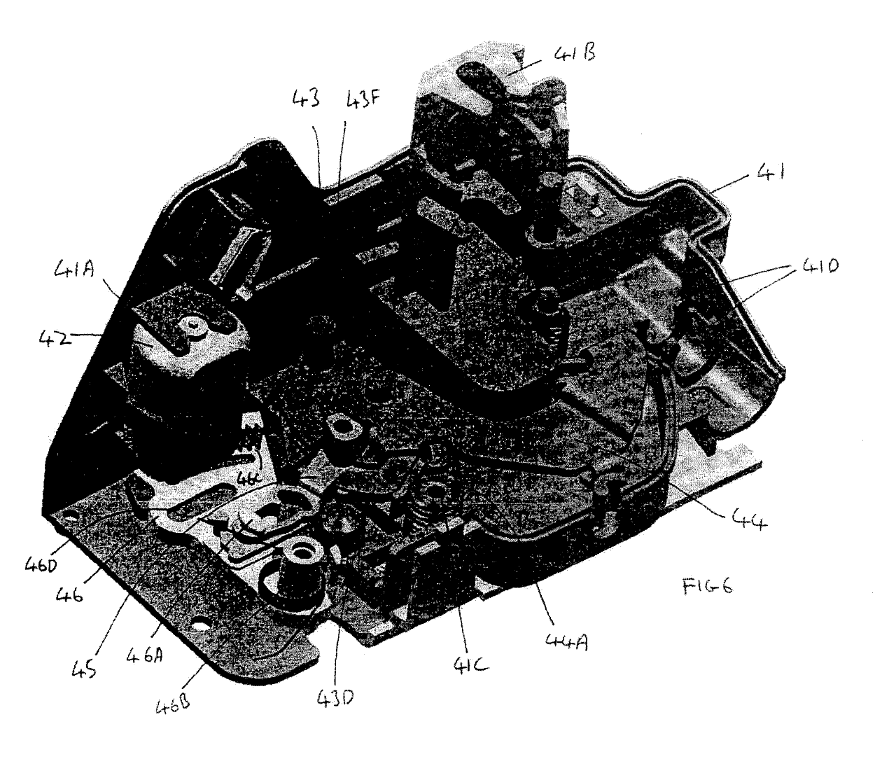

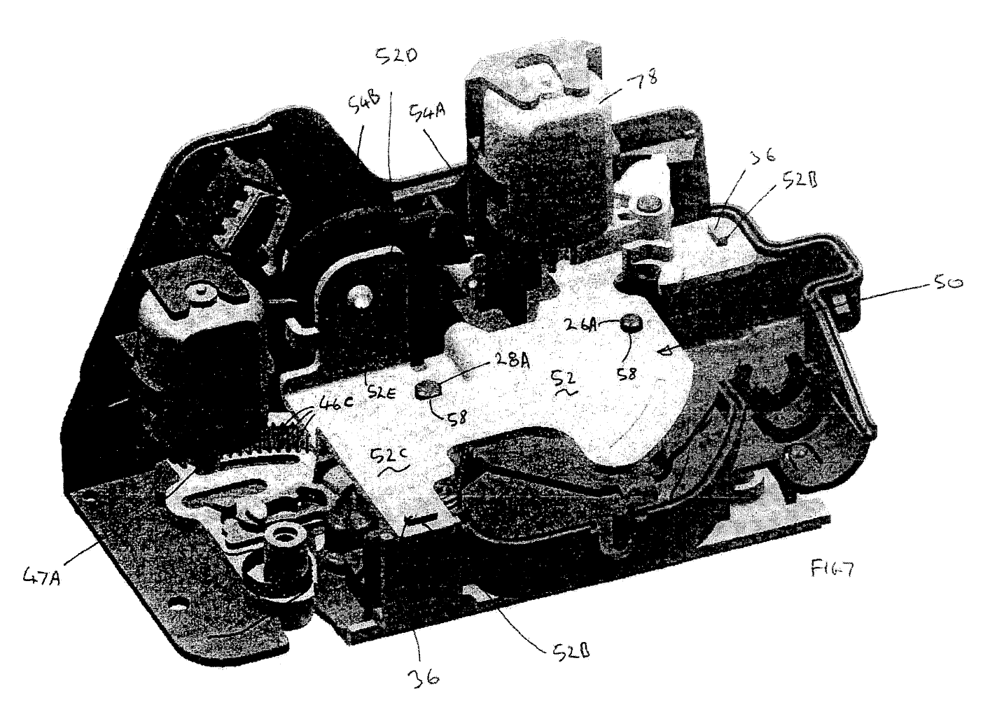

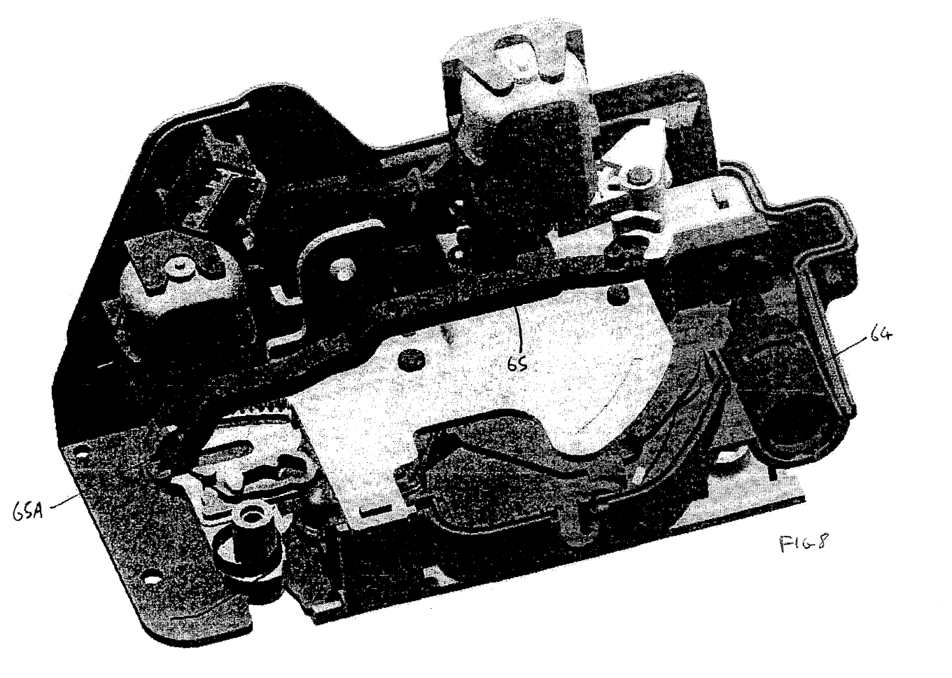

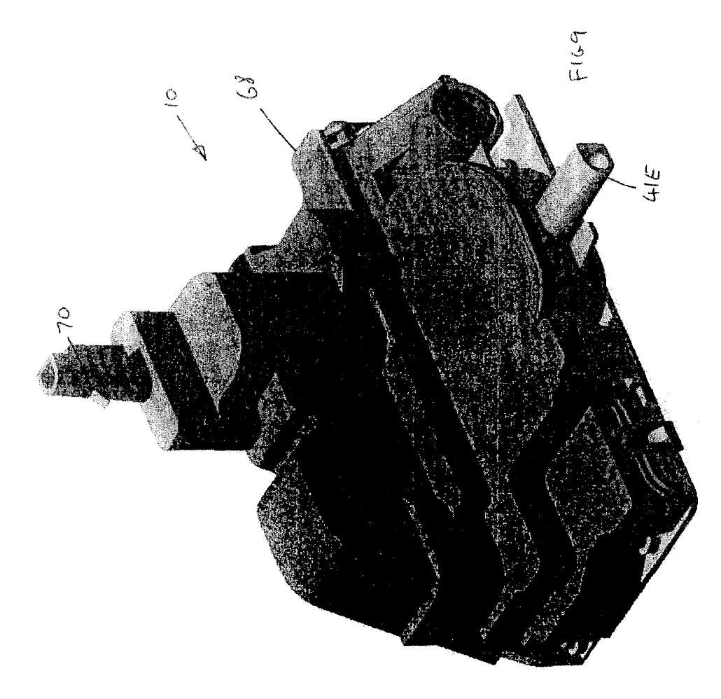

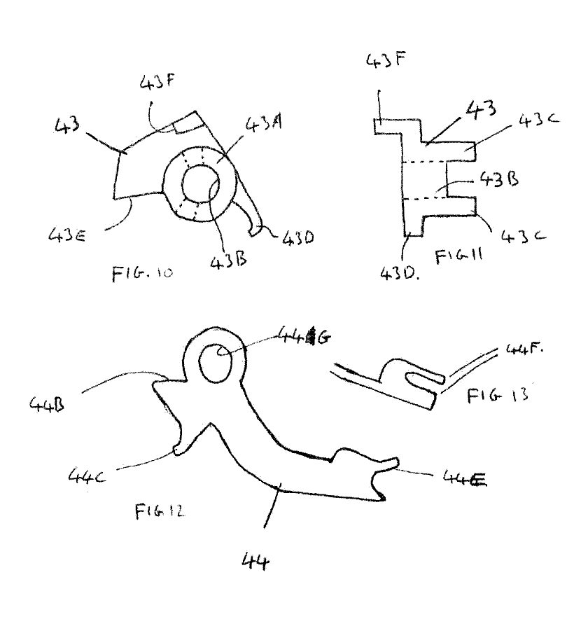

FIG. 4 illustrates a latch assembly 10 containing modular sub-assemblies according to one embodiment of the invention. FIG. 3 illustrates a retention module sub-assembly 20 incorporated in the inventive latch assembly 10. The retention module sub-assembly 20 includes a retention plate 22 having a mouth 24 for receiving a striker (not shown). The retention plate 22 includes a fixed claw pin 26, which projects from the retention plate 22. A fixed pawl pin 28 also projects from the retention plate 22. The retention plate 22 includes mounting structures for attaching the latch assembly 10 to a vehicle door (not shown). In the embodiment shown in FIG. 3, the mounting structures are three threaded holes 25 through which screws are threaded to secure the latch assembly 10 to the door.

The retention plate 22 has a first portion 23A which is generally planar and includes the threaded holes 25. The pawl and claw pins 28, 26 project from this first portion. Part of the first portion 23A is also cut away to form part of the mouth 24. The retention plate 22 also includes a second portion 23B that also has a cutaway portion to form part of the mouth 24. The second portion 23B is positioned at substantially 90° relative to the first portion 23a.

The retention plate 22 may also have tabs 35 that are bent from the first portion 23A and that are positioned at substantially 90° relative to the first portion 23A. Each tab 35 includes a lug 36 at an end remote from the first portion 23A.

A claw 27 is rotatably mounted on the claw pin 26. The claw 27 includes a mouth 27A for releasably retaining the striker. The claw 27 further includes a first safety abutment 27B and a closed abutment 27C. A claw spring 30 biases the claw 27 to an open position.

A pawl 29 is mounted on the pawl pin 28 and includes a pawl tooth 32 that engages with the first safety abutment 27B or the closed abutment 27C of the claw 27 to retain the claw 27 in the first safety position or the closed position, respectively. The retention module 20 further includes a pawl spring 34 that biases the pawl 29 into engagement with the claw 27.

The claw 27, claw spring 30, pawl 29 and pawl spring 34 are all fixed to the retention plate 22 to form a stable retention module sub-assembly 20. The term “stable sub-assembly” is used throughout this detailed description to describe a sub-assembly where the components in the sub-assembly cannot fall off the sub-assembly regardless of the vibratory and gravitational forces on the sub-assembly during transit and regardless of the orientation of the sub-assembly.

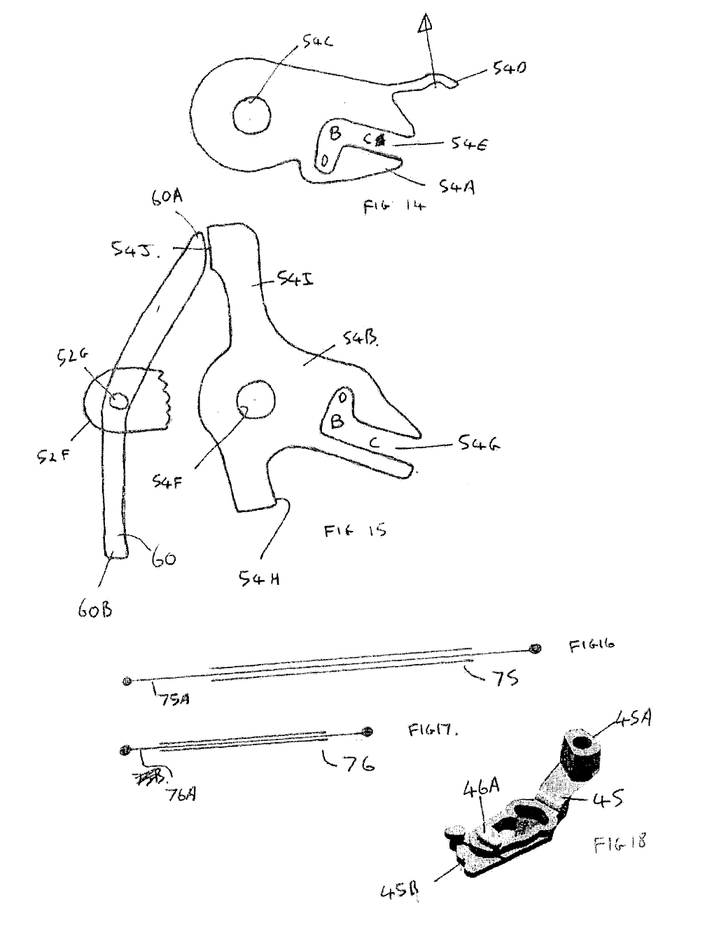

Referring to FIG. 2, the latch assembly 10 also includes a release module subassembly 40. In one embodiment, the release module sub-assembly 40 is attached to the retention module sub-assembly 20 when forming the latch assembly 10. The release module sub-assembly 40 includes a body 41, a pawl lifter 43 (best seen in FIGS. 10 and 11), an outside release lever 44, an outside release lever bias spring 44A (best seen in FIG. 6), a lock link 45 (best seen in FIGS. 6 and 18), and a lock link lever 46.

In one embodiment, the body 41 is manufactured from injection-molded plastic and forms part of a housing for the various components of the latch assembly 10. The body 41 may include a lock motor mounting 41A and a superlock motor mounting 41B. The body 41 may also include a boss 41C (best seen in FIGS. 2 and 9) for receiving an outside release lever spring 44A. Clips 41D may also be provided to receive part of a key mechanism. A cylindrical boss 41E (FIG. 6) is provided to receive a Bowden cable 75 or 76, depending on the particular installation.

A superlock motor 78 can be mounted in the superlock motor mounting 41B. Selective operation of the superlock motor 78 will cause the latch assembly 10 to be superlocked or non-superlocked as desired.

The pawl lifter 43 includes a generally cylindrical body portion 43A having a central hole 43B that fits over the pawl pin 28. Two lugs 43C project from the cylindrical body portion 43A and engage the recesses 29A of the pawl 29 to rotationally secure the pawl lifter 43A with the pawl 29.

An arm 43D projects tangentially from the body portion 43A. Depending upon the particular embodiment, a resilient member (not shown) may act on the arm 43D to bias the pawl lifter 43, and therefore the pawl 29, in a counter-clockwise direction when viewed from the perspective shown in FIG. 10. This resilient member can be used in place of the pawl spring 34 if desired.

The pawl lifter 43 may also include an outside release abutment 43E and an inside release abutment 43F. The outside release abutment 43E is acted upon by an outside release lever 44 and the inside release abutment 43F is acted upon by the inside release lever 54, as will be further described below.

The outside release lever 44 (best seen in FIGS. 12 and 13) includes a hole 44G that receives the pawl pin 29. An abutment 44B is provided for use in conjunction with the outside release abutment 43E. A lug 44C is engaged by a spring 44A to bias the outside release lever 44 in a counter-clockwise direction when viewed from the perspective shown in FIG. 12. An end 44E of the outside release lever 44 includes a fork 44F that is engaged by a Bowden cable 75A or 76A, as will be described in further detail below.

The lock link 45 includes an abutment 45A that sits between the outside release abutment 43E of the pawl lifter 43 and abutment 44B of the outside release lever when the latch assembly 10 is in an unlocked condition. Thus, movement of the outside release lever 44 in a clockwise direction (when viewed from the perspective shown in FIG. 12) causes the abutment 44B to engage the lock link abutment 45A. This engagement causes the lock link abutment 45A to also to move in a clockwise direction, thereby contacting and moving the outside release abutment 43E of the pawl lifter 43 in a clockwise direction. The clockwise rotation of the pawl lifter 43 in turn moves the pawl 29 so that the pawl 29 disengages from the claw 27.

The end 45B of the lock link 45 engages with a pin 46A of the lock link lever 46. The lock link lever 46 is pivotable around one end 46B and can be moved in a counterclockwise direction (from the perspective shown in FIG. 6) by a lock motor 47 acting via a pinion 47A (best seen in FIG. 7) on an array of teeth 46C of the lock link lever 46. Thus, in use, the lock motor 42 can be powered to move the lock link abutment 45A between the abutment 44B of the outside release lever and the outside release abutment 43E of the pawl lifter 43 to unlock the latch. Alternatively, the lock motor 42 can be powered to withdraw the lock link abutment 45A from the space between the abutment 44B of the outside release lever and the outside release abutment 43E to unlock the latch. The lock motor 42 may be configured to provide unlocking of the latch upon operation of an inside door handle (i.e., a power override unlocking function).

It is also possible to lock the latch by using a key mechanism, which will be described in further detail below.

The release module sub-assembly 40 may further include a power unlatching actuator (not shown), operable to power unlatch the latch. The release module subassembly 40 is a stable sub-assembly and is mounted onto the retention module subassembly 20 in a direction of arrow A shown in FIG. 3 such that the claw pin 26 and pawl pin 28 pass through the release module sub assembly 40.

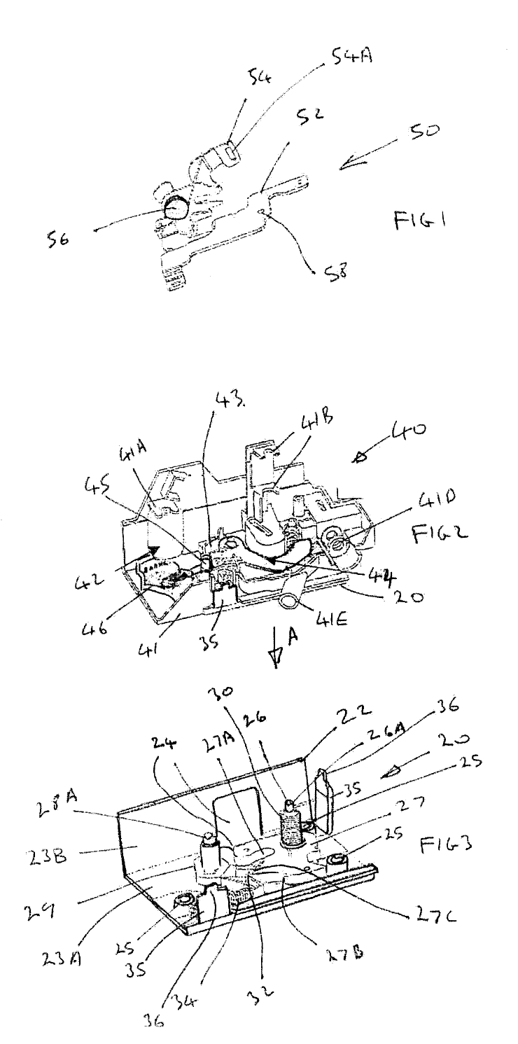

FIG. 1 shows an actuator module sub-assembly 50 (also referred to as an inside release lever module sub-assembly, or backplate module sub-assembly) having a backplate 52. Although the example described below assumes that the actuator module sub-assembly 50 corresponds with an inside release lever and an inside door handle, it can also be associated with other release levers and/or door handles without departing from the scope of the invention. The actuator module sub-assembly 50 is a stable subassembly. The backplate 52 includes holes 58 that accommodate the ends 26A and 28A of the claw pin 26 and pawl pin 28, respectively (best seen in FIG. 7). The backplate 52 further includes rectangular holes 52B through which the lugs 36 can pass. To secure the backplate 52 to the retention module sub-assembly 20, the ends 26a and 28a are deformed to form rivet heads. The lugs 36 are similarly deformed to form a secure attachment structure.

The backplate 52 includes a first portion 52C that lies generally in the same plane as the first portion 23A of the retention plate 23. The first portion 52C of the backplate includes holes 58 and rectangular holes 52B. A second portion 52D of the backplate 52 is bent at substantially 900 with respect to the first portion 52C of the backplate. The second portion 52D of the backplate 52 lies substantially parallel to the second portion 23B of the retention plate 23. The second portion 52D includes a hole through which a pin 52E is passed to secure an inside release lever 54.

The inside release lever 54 comprises a first part 54A and a second part 54B (best seen in FIGS. 14 and 15). The first part 54A includes a hole 54C for receiving the pin 52E from the backplate 52. A fork 54D provides a connection with a Bowden cable inner cable. The first part 54A also includes an L-shaped recess 54E. The second part 54B of the inside release lever includes a hole 54F that receives the pin 52E from the backplate 52. The second part 54B also includes an L-shaped recess 54G. The inside release lever 54 also includes a pawl lifter abutment 54H and an arm 541 having an override abutment 54J. When assembled, the first and second parts 54A and 54B of the inside release lever 54 are both rotatably mounted on the pin 52E of the backplate via the holes 54C and 54F. As such, regions B and C of the L-shaped recesses 54E and 54G are aligned. To provide child safety or superlocking functions, a pin (not shown) can be positioned in region B so that counter-clockwise movement of the first part 54A does not cause movement of second part 54B since the pin moves relative to the first and second parts to region D.

When child safety function is off, or when the lock is not superlocked, the pin sits in region C. Thus, counter-clockwise movement of the first part 54A of the inside release lever causes counter-clockwise movement of the second part 54B since both parts are coupled together by the pin. Counter-clockwise movement of the second part 54B causes pawl lifter abutment 54H to engage and move the internal release abutment 43F of the pawl lifter 43. This causes the pawl lifter 43 to rotate in a clockwise direction (from the perspective shown in FIG. 10, thereby disengaging the pawl 29 from the claw 27 and allowing the latch to open.

In a further embodiment, the second part 52D of the backplate 52 can include an extension 52F having a pin 52G secured thereto. An override unlock lever 60 is pivotally mounted on the pin 52G. An end 60A of the override unlock lever 60 is engageable by an override abutment 54J. Another end 60B of the override unlock lever 60 is engageable with the lock link lever 46. Counter-clockwise movement of the second part 54B of the inside release lever causes counter-clockwise rotation of the override unlock lever 60 around the pivot 52G. This in turn causes the second end 60B of the lever 60 to engage with and move the lock link lever 46, thereby unlocking the door.

FIGS. 5 to 9 show the assembly sequence of a second embodiment of a latch. FIG. 5 shows the retention module sub-assembly 20, FIG. 6 shows the release module sub-assembly 20 assembled onto the retention plate, FIG. 7 shows the latch assembly after the backplate 52 has been attached, and FIG. 8 shows the latch assembly after attachment of a key mechanism.

Referring to FIG. 8, the key mechanism according to one embodiment of the invention includes a rod 65 that can be moved longitudinally by operation of a key. Drive power to the rod 65 comes via a key barrel mounted on the door and connected to a key mechanism barrel 64. One end 65A of the rod 65 is engaged in a slot 46D of the lock link lever 46 (FIG. 6). Longitudinal movement of the rod 65 toward the left (from the perspective shown in FIG. 8) causes the lock link lever 46 to move so that the lock link abutment 45A is withdrawn from the gap between the abutment 44B on the outside release lever and the outside release abutment 43E of the pawl lifter 43, thereby locking the latch. Conversely, longitudinal movement of the rod 65 toward the right causes end 65A of the rod to move to the other end of the slot 46D in the lock link lever 46, moving the lock link lever 46 so that the lock link abutment 45A moves between abutments 44B and 43E, thereby unlocking the latch.

As shown in FIG. 9, a cover 68 is then placed over the latch and secured. An outside release cable then can be inserted through a cylindrical boss 41E such that the cable engages with the fork 44F on the outside release lever 44, thereby coupling the cable with the outside release lever 44. A similar operation can connect an additional cable through boss 70 to the fork 54D on the inside release lever. The orientation of the bosses 41E and may be in any desired direction to provide any desired cable routing.

It should be appreciated that different sub-assembly module structures and combinations can be provided, depending upon the particular requirements of a given latch assembly, without departing from the scope of the invention. For example, a pawl bias spring may be included on the retention module sub-assembly 20 (FIG. 3) or the release module sub-assembly 40. A claw bias spring may also be included in the release module sub-assembly 40 or the retention module sub-assembly 40 (FIG. 3).

Further, the release module sub assembly 40 may include a lock motor 42 that can either be fitted or non-fitted. When the motor 42 is not fitted, the lock link lever 46 can still be fitted, making the teeth 46C of the lock link lever 46 redundant. A superlock motor (not shown) also may be included and may or may not be fitted to the superlock motor mounting 41B. The latch assembly 10 may also have different bodies that may or may not include motor mountings 41A, superlock motor mountings 41B, or clips 41D.

The actuator module sub-assembly 50 can include a two-piece inside release lever 54 (FIG. 7) or a one-piece inside release lever. Note that if the inside release lever is a single piece, it is not possible to provide child safety or superlocking of the latch. Thus, such a latch would be used on a two-door car where superlocking is not required. The inside release lever may or may not include an override abutment 54J. Further, the backplate 52 may or may not include an override unlocking lever 60. In particular, it will be appreciated that a latch may not include an override unlock lever 60, but may nevertheless include a redundant extension 52F on the backplate 52 and a redundant override abutment 54J on the inside release lever 54.

Thus, the varied features in the inventive latch assembly makes it possible to utilize these features in any combination while still allowing elimination of certain features for latches that do not require them. This allows the total part count of the latch to be minimized.

Further, the modular sub-assemblies in the invention makes it possible to make different latch assemblies from the same collection of sub-assemblies. For example, a first latch assembly may comprises a retention module sub-assembly 20, one form of release module sub-assembly 40 and the actuator module sub assembly 50 while a second latch assembly could comprise a retention module sub-assembly 20, a different form of release module sub-assembly 40 and the actuator module sub-assembly 50. Different latch assemblies may also be formed by using common retention module sub assemblies and release module sub assemblies, but different actuator module sub-assemblies.

For example, the specification of a low-line latch assembly may call for manual release only, with no power release functionality. -The low-line specification might further call for a mechanical override unlocking mechanism (especially lever 60) as well as a mechanical connection to an outside key barrel (e.g., rod 65), without any power override unlocking or power locking. A medium-level latch assembly might also call for manual release, but provide a power actuator for override unlocking and regular locking/unlocking.

A high-level latch assembly would include power release, power override unlocking and power locking/unlocking. The modular sub-assemblies provided in the inventive latch assembly allow each of these latch assemblies to be constructed by simply substituting different sub-assemblies without having to redesign the entire latch assembly.

It should be understood that various alternatives to the embodiments of the invention described herein may be employed in practicing the invention. It is intended that the following claims define the scope of the invention and that the method and apparatus within the scope of these claims and their equivalents be covered thereby.

1. A latch assembly comprising:
a retention module sub-assembly including a retention plate having a mouth to accept a striker, a claw for releasably retaining a striker, and a pawl engageable with the claw for retaining the striker;
a release module sub-assembly including a pawl lifter operably coupled to the pawl to release the striker; and
an actuator module sub-assembly including a backplate and a release lever operably coupled to the pawl lifter to selectively move the pawl lifter,
wherein the retention module sub-assembly, the release module sub-assembly, and the actuator module sub-assembly are discrete modular components.

2. The latch assembly of claim 1, wherein the release module sub-assembly is disposed in the latch assembly between the retention module sub-assembly and the actuator module sub-assembly.

3. The latch assembly of claim 1, wherein the claw in the retention module sub-assembly is pivotally mounted on a claw pin fixed to the retention plate and wherein the pawl is pivotally mounted on a pawl pin fixed to the retention plate.

4. The latch assembly of claim 3, wherein the release module sub-assembly is positioned over the claw and pawl pins on the retention plate.

5. The latch assembly of claim 3, wherein the actuator module sub-assembly is positioned over the claw and pawl pins on the retention plate.

6. The latch assembly of claim 3 in which the claw and pawl pins each have a fixing structure to secure at least one of the actuator module sub-assembly, and the release module sub-assembly to the retention module sub-assembly.

7. The latch assembly of claim 6, wherein the fixing structure is a deformable end.

8. The latch assembly of claim 1, wherein at least one of the retention module sub-assembly and the release module sub-assembly includes a claw biasing device that biases the claw to an open position.

9. The latch assembly of claim 1, wherein at least one of the retention module sub-assembly and the release module sub-assembly includes a pawl bias device that biases the pawl to an engaged position.

10. The latch assembly of claim 1, wherein the release module sub-assembly includes an outside release lever operably coupled to the pawl lifter to selectively move the pawl lifter.

11. The latch assembly of claim 1, wherein the release module sub-assembly further includes a lock link operable to lock and unlock the latch assembly.

12. The latch assembly of claim 1, wherein the lock link is operable via at least one selected from the group consisting of an outside key barrel and a lock motor.

13. The latch assembly of claim 1, wherein the release module sub-assembly further includes a lock motor operable to lock and unlock the latch assembly.

14. The latch assembly of claim 13, wherein the lock motor is operable upon actuation of an inside release lever to provide a power override unlocking function.

15. The latch assembly of claim 1, wherein the release module further includes a superlock motor operable to superlock and unsuperlock the latch assembly.

16. The latch assembly of claim 1, wherein the actuator module sub-assembly further includes an override lever operably coupled to the inside release lever to mechanically overrides unlocking when the inside release lever is operated.

17. The latch assembly of claim 1, wherein the inside release lever is a two-piece lever.

18. The latch assembly of claim 1, wherein at least one of the retention module sub-assembly, the release module sub-assembly, and the actuator module subassembly is a stable sub-assembly.

19. A method of assembling a latch assembly, comprising:
selecting a retention module sub-assembly including a retention plate having a mouth to accept a striker, a claw for releasably retaining a striker, and a pawl engageable with the claw for retaining the striker;
selecting a release module sub-assembly including a pawl lifter operably coupled to the pawl to release the striker;
selecting an actuator module sub-assembly including a backplate and a release lever operably coupled to the pawl lifter to selectively move the pawl lifter, wherein the retention module sub-assembly, the release module sub-assembly, and the actuator module sub-assembly are discrete modular components; and
connecting the retention module sub-assembly, the release module sub-assembly, and the actuator module sub-assembly together to form the latch assembly.

20. The method of claim 19, wherein the step of selecting a retention module sub-assembly comprises selecting from at least two retention module sub-assemblies having different operating characteristics.

21. The method of claim 19, wherein the step of selecting a release module sub-assembly comprises selecting from at least two release module sub-assemblies having different operating characteristics.

22. The method of claim 19, wherein the step of selecting an actuator module sub-assembly comprises selecting from at least two actuator module sub-assemblies having different operating characteristics.
